(19) United States
(12) Patent Application Publication
(10) Pub. No.: US 2004/0166479 A1
(43) Pub. Date: Aug. 26, 2004

(54) System and method for language learning through listening and typing

(76) Inventors: Sayling Wen, Taipei (TW); Zechary Chang, Taipei (TW); Leger Wu, Beijing (CN)

Correspondence Address: BIRCH STEWART KOLASCH & BIRCH, PO BOX 747, FALLS CHURCH, VA, 22040-0747, US

(21) Appl. No.: 10/372,826

(22) Filed: Feb. 26, 2003

(51) Int. Cl. G09B 19/00

(52) U.S. Cl. 434/156

(57) ABSTRACT

A system and method for assisting language learning through process of listening and typing. A learner listens to a speech, answers questions by typing. The process helps the learner memorizing through keying answering text. The system monitors the learner's response and provides dynamic hints for finishing the answer so as to increase the learner's interest and to improve learning efficiency. A system of the invention includes a speech database, a speech playing module, a dynamic hints module, an input analysis module, an input monitoring module and a playing setting module. A method of the invention includes steps of: playing speech to the learner; receiving learner's response to the speech playing; providing dynamic analysis and hints to help the learner's response, and finally providing checking results for the learner's inputs.

### BACKGROUND OF THE INVENTION

1. Field of the Invention

The invention generally relates to a system and method for assisting language learning, and particularly relates to a system and method for assisting language learning through process of listening and typing.

2. Related Art

As international traffic and communication being convenient and frequent today, the whole world becomes a village that no single place is isolated. Frequent interactions among different countries and different people make language learning more important and necessary.

In language learning, listening comprehension is an important aspect. A general method for learning a language is to listen repeatedly to a tape or the like. The learner repeatedly listens to a sentence or a paragraph, imitates and practices with pronounce and tone. This process of mechanical listening and speaking spands a lot of time, but the learner does not realize how much he or she has really learned and achieved. In some cases, the learner even just imitates like a parrot that he or she does not pay attention to the meaning of language materials so the learning is not effectively achieved.

Recently there is a reading monitoring system trying to analyze the learner's speech and provide suggestions to the learner after he or she speaks a sentence or a paragraph. The monitoring and suggestion system tries to improve learner's listening and speaking. However, the current speech analysis techniques are still limited with their capabilities for precise comparisons. On the other hand, a typing training requires the learner first knowing the word and the spelling before typing it correctly. The process of knowing and using the words helps the learner recognizing the word or sentence and achieving an effective learning. However, this kind of typing training has not been utilized in conventional language learning methods. Therefore, the invention provides a method for learning a language by incorporating typing process so as to help the learner recognizing the words and sentences and improving the learner's listening comprehension.

### SUMMARY OF THE INVENTION

The object of the invention is to provide a system and method for assisting language learning through process of listening and typing. After the learner listens to a learning material, the system checks the learner's input, compares it with bi-lingual text records and provides instructions for improving the learner's listening and memorization, and facilitating a high efficient learning. During the learner's input, the system also provides suitable hints to help the learner responding and to increase the learner's interest.

A system for assisting language learning through process of listening and typing according to the invention includes a speech database for storing speech information; a speech playing module for playing speech; means for receiving learner's response to the speech playing; a dynamic hints module for helping the learner's response, and an input analysis module for providing bi-lingual checking results for the learner's inputs.

A method for assisting language learning through process of listening and typing according to the invention includes steps of: playing speech to the learner; receiving learner's response to the speech playing; providing dynamic analysis and hints to help the learner's response, and finally providing bi-lingual checking results for the learner's inputs.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a block diagram of a system for assisting language learning through process of listening and typing according to the invention;

FIG. 2 is a flowchart of a method for assisting language learning through process of listening and typing according to the invention;

FIG. 3 is a detailed flowchart of a step of providing analysis and hints in a method for assisting language learning according to the invention.

### DETAILED DESCRIPTION OF THE INVENTION

The invention provides a system and method for assisting language learning through process of listening and typing.

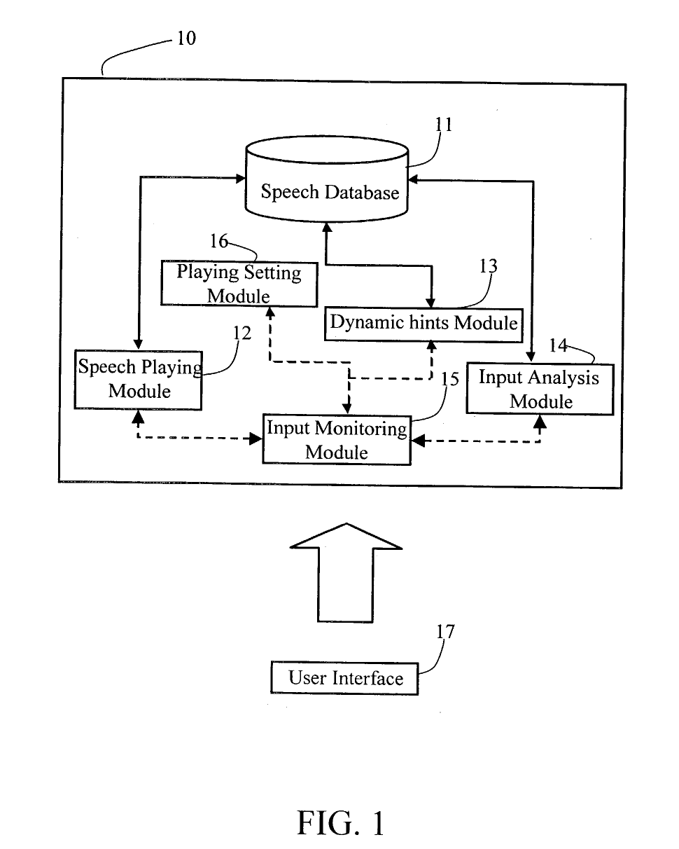

As shown in FIG. 1, a preferred embodiment of the invention includes:

a) a speech database 11 for storing speech information. Each speech record includes a speech file, bi-lingual texts and a speech ID number. The speech files record the human speaking of the instructional materials, such as training questions of vocabularies, phrases and sentences. Each training question includes individual language and a bi-lingual version of two languages (in Chinese or in English). Each speech file is related with answering texts of two languages that are used for comparison of learner's input and hints for helping learners to respond. For example, in a vocabulary question file, a speech file “This is a book” relates to bi-lingual text records of “This is a book” in English and “This is a book” in Chinese. Each speech record also includes a corresponding speech ID number.

b) a speech playing module 12 for playing speech randomly according to a randomized number generated by a randomizer. The randomized number is used to get the speech file from the speech database by the speech ID number.

c) a dynamic hints module 13 for providing hints to the learner when the learner retards to respond to a question over a preset time period, for example 3 seconds. That is, when the learner cannot finish typing in an answering queue, the system gives hints by displaying or flashing a character or a word according to the bi-lingual text records so as to help the learner answering and increase the learner's interest.

d) an input analysis module 14 for analyzing the learner's text input (through interfaces such as keyboard, mouse or tablet) with the bi-lingual text records (in Chinese or in English). The input analysis module 14 compares the learner's text input in a first in first out manner with the bi-lingual text records, computes a correctness rate to inform the difference to the learner, displays the correct bi-lingual texts to enhance listening comprehension and memorization of the learner so as to increase the efficiency of learning through listening.

e) an input monitoring module 15 for monitoring the learner's operations (such as play, pause, stop, difficulty selection, system setting, help, etc.) through the user interface 17 and generating corresponding control signals for the related modules to display or execute.

f) a playing setting module 16 for registering the learner's settings for the listening and typing process, including settings of playing, such as the playing speed, kinds of questions, difficulty of questions, and settings for the hints, such as permissible retarding time, hints or not and so on.

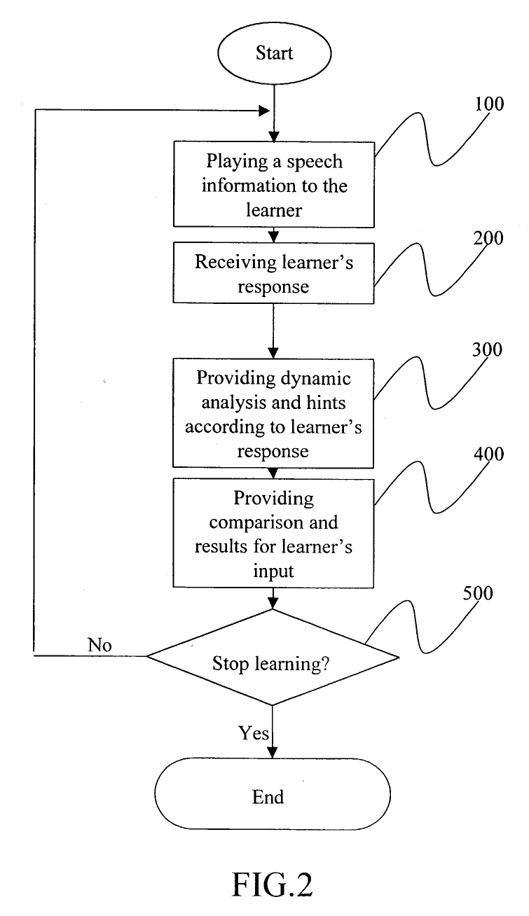

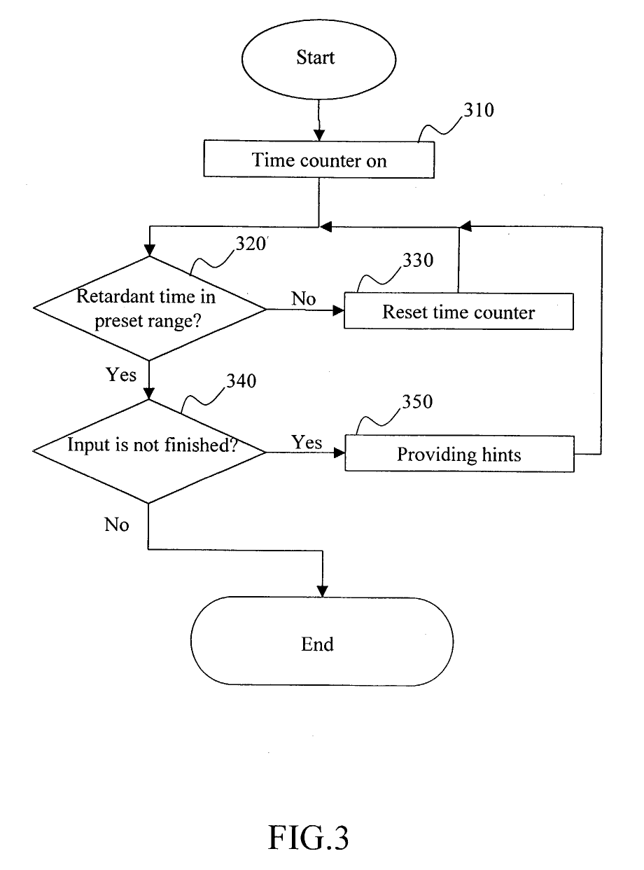

FIG. 2 shows a flowchart of a method for assisting language learning through process of listening and typing according to the invention. It includes the following steps. First, playing speech to the learner (step 100). The speech is played randomly according to a randomized number generated by a randomizer and used as a speech ID number to get the speech file from a speech database. Then, receiving learner's response to the speech playing (step 200). That is, to monitor the learner's text input. Then, providing dynamic analysis and hints to help the learner's response (step 300). The hints are provided when the learner cannot proceeds a correct answer in a preset retarding time period. A detailed process for the analysis and hints will be described hereinafter with FIG. 3. Finally, providing bi-lingual checking results for the learner's inputs (step 400). The learner's text input is compared with bi-lingual text records, computed as a correctness rate, and displayed with the difference. Further, the system checks whether the learner wants to stop (step 500). If yes, it continues a new playing (step 100). Otherwise, it stops the process.

FIG. 3 shows a detailed flowchart of the step 300 of providing analysis and hints in a method of FIG. 2. First, starting a time counter (step 310) after the learner starts to answer. Then, checking if the user retards to input the answer in a preset time period (such as 3 seconds) (step 320). The system resets the time counter whenever the learner inputs (step 330). When the time exceeds, the system checks if the learner has finished the answer (step 340). If the answer is finished, i.e., the answering text has been filled in the queue, the dynamic analysis and hints process is then stopped and the final comparison process starts. Otherwise, the answering queue is not filled up; the system generates hints (step 350), such as a word or character step by step, to help the learner answering; then, resets the time counter. The checking and dynamic hints continue till the learner finishing the answer.

In conclusion, the system and method for assisting language learning through process of listening and typing according to the invention can help the learner memorizing through keying answering text and having dynamic hints to finish the answer. The process dynamically decreases the difficulty of learning, increases the learner's interest and improves the learning efficiency.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for assisting language learning through process of listening and typing, comprising:
a speech database for storing at least a record of speech information;
a speech playing module for playing speech according to a randomized number corresponding to said record of speech information;
a dynamic hints module for helping a learner's response when said learner retards to respond;
an input analysis module for analyzing said learner's text input with a text record; and
an input monitoring module for monitoring said learner's operations and generating corresponding control signals to said other modules.

2. A system for assisting language learning through process of listening and typing according to claim 1 further comprises a playing setting module for registering learner's settings for said listening and typing process.

3. A system for assisting language learning through process of listening and typing according to claim 2, wherein a setting of said listening and typing process is selected from the group consisting of a vocabulary training, a phrase training and a sentence training.

4. A system for assisting language learning through process of listening and typing according to claim 2, wherein a setting of said listening and typing process is selected from the group consisting of a Chinese speech, a English speech and a bi-lingual speech mode.

5. A system for assisting language learning through process of listening and typing according to claim 1, wherein each of said speech information record comprises at least a speech file, a bi-lingual texts and a speech ID number.

6. A system for assisting language learning through process of listening and typing according to claim 1, wherein said dynamic hints module provides step by step at least a hint character of a text queue based on a text record when said learner retards to fill up said text queue.

7. A system for assisting language learning through process of listening and typing according to claim 1, wherein said learner responds with text input through an input device.

8. A system for assisting language learning through process of listening and typing according to claim 1, wherein said input analysis module compares said learner's response from a text queue in a first in first out manner with a text record and generates a comparison result.

9. A system for assisting language learning through process of listening and typing according to claim 1, wherein said input analysis module provides analysis results of correctness rate of said learner's response and bi-lingual text records for improving said learner's listening and learning efficiency.

10. A method for assisting language learning through process of listening and typing, comprising steps of:
playing speech to a learner;
receiving said learner's response to said speech playing;
providing dynamic analysis and hints to help said learner's response, and
providing a comparison result for said learner's response.

11. A method for assisting language learning through process of listening and typing according to claim 10, wherein said step of providing dynamic analysis and hints further comprises steps of:
starting a time counter;
checking a retarding time of said learner's response; and
checking conditions of said learner's response and provides hints based on a text record when said learner retards to fill up a text queue.

12. A system for assisting language learning through process of listening and typing according to claim 10, wherein said speech is selected from the group consisting of a Chinese speech, a English speech and a bi-lingual speech mode.

13. A system for assisting language learning through process of listening and typing according to claim 10, wherein said learner's inputing is selected from the group consisting of a Chinese, a English and a bi-lingual mode.

14. A method for assisting language learning through process of listening and typing according to claim 10, wherein speech is selected from the group consisting of a vocabulary training, a phrase training and a sentence training.

15. A method for assisting language learning through process of listening and typing according to claim 10, wherein said dynamic analysis is to compare said learner's response from a text queue in a first in first out manner with a text record and generates a comparison result.

16. A method for assisting language learning through process of listening and typing according to claim 15, wherein said comparison result comprises an index of said learner's response and bi-lingual text records for improving said learner's listening and learning efficiency.

17. A method for assisting language learning through process of listening and typing according to claim 16, wherein said index of said learner's response is a correctness rate.

18. A method for assisting language learning through process of listening and typing according to claim 10 further comprises a step of resetting said time counter when said retarding time of said learner's response does not exceed a preset time period.
